(19) United States
(12) Patent Application Publication
(10) Pub. No.: US 2021/0237471 A1
(43) Pub. Date: Aug. 5, 2021

(54) CORRECTION VALUE SETTING METHOD, TEST PATTERN RECORDING METHOD AND TEST PATTERN RECORDING DEVICE

(71) Applicant: SEIKO EPSON CORPORATION, Tokyo (JP)

(72) Inventor: Takuma HAYASHI, Matsumoto (JP)

(21) Appl. No.: 17/161,806

(22) Filed: Jan. 29, 2021

(30) Foreign Application Priority Data
Jan. 31, 2020 (JP) 2020-014612

(51) Int. Cl. B41J 2/21; H04N 1/405; B41J 2/045; H04N 1/407

(52) U.S. Cl. CPC B41J 2/2132; H04N 1/4078; B41J 2/04551; H04N 1/4057

(57) ABSTRACT

A recording step for driving a recording head having a plurality of nozzles arranged in a first direction, and recording a TP in which a plurality of patches having densities different from each other are arranged in a second direction, a reading step, a calculating step for calculating a correction value for each raster line, and a setting step for setting the correction value for each raster line as a correction value to be used for recording processing are included, and among the plurality of patches constituting the TP, when a highest density patch is a first patch and patches other than the first patch are second patches, in the recording step, a length in the second direction of the first patch is made greater than a length in the second direction of at least one of the second patches and the TP is recorded.

The present application is based on, and claims priority from JP Application Serial Number 2020-014612, filed Jan. 31, 2020, the disclosure of which is hereby incorporated by reference herein in its entirety.

### BACKGROUND

### 1. Technical Field

The present disclosure relates to a setting method of a correction value to be used for recording processing, a test pattern recording method for calculating a correction value, and a test pattern recording device.

### 2. Related Art

A technique has been disclosed in which, in order to obtain a correction value for correcting density irregularity for each raster line, a plurality of band-like correction patterns having different densities for respective CMYK ink colors are printed on a sheet, and a correction value is set based on measurements of these correction patterns by a scanner (see WO 2005/042256).

In order to obtain an appropriate correction value, it is necessary to accurately measure the pattern recorded on the sheet. However, in particular, with a high density pattern, measurements lacking relative accuracy were easily obtained due to effects from a vicinity of the pattern, structure of a recording head for recording the pattern, and the like.

### SUMMARY

A correction value setting method includes a recording step for driving a recording head having a plurality of nozzles arranged in a first direction to discharge ink from the nozzles, thereby recording a test pattern in which a plurality of patches having densities different from each other are arranged in a second direction that intersects the first direction on a recording medium, a reading step for reading the test pattern recorded on the recording medium, a calculating step for, based on a value read from the test pattern by the reading step, calculating a correction value for each raster line elongated in the second direction recorded by one or more of the nozzles in the test pattern, that is a correction value for correcting an ink amount, and a setting step for setting a correction value for each raster line as a correction value to be used for recording processing, wherein when a patch with a maximum density of the plurality of patches constituting the test pattern is a first patch, and patches other than the first patch among the plurality of patches constituting the test pattern are second patches, the test pattern is recorded, in the recording step, so that a length in the second direction of the first patch is greater than a length in the second direction of at least one of the second patches.

In a test pattern recording method for driving a recording head having a plurality of nozzles arranged in a first direction to discharge ink from the nozzles, thereby recording a test pattern on a recording medium, when a patch with a maximum density in the test pattern in which a plurality of patches having densities different from each other are arranged in a second direction that intersects the first direction is a first patch, and patches other than the first patch among the plurality of patches constituting the test pattern are second patches, the test pattern is recorded so that a length in the second direction of the first patch is greater than a length in the second direction of at least one of the second patches.

In a test pattern recording device for driving a recording head having a plurality of nozzles arranged in a first direction to discharge ink from the nozzles, thereby recording a test pattern on a recording medium, when a patch with a maximum density in the test pattern in which a plurality of patches having densities different from each other are arranged in a second direction that intersects the first direction is a first patch, and patches other than the first patch among the plurality of patches constituting the test pattern are second patches, the test pattern is recorded so that a length in the second direction of the first patch is greater than a length in the second direction of at least one of the second patches.

### BRIEF DESCRIPTION OF THE DRAWINGS

FIG. 1 is a block diagram simply illustrating a configuration about the present exemplary embodiment.

FIG. 2 is a view illustrating a relationship between a recording medium and a recording head from a viewpoint from above.

FIG. 3 is a flowchart illustrating a correction value setting method.

FIG. 4A is a diagram illustrating an example of a test pattern, and FIG. 4B is a diagram illustrating another example of the test pattern.

FIG. 5 is a diagram illustrating a test pattern for each ink color.

FIG. 6 is a diagram for explaining correction value calculation.

FIG. 7 is a diagram illustrating a correction value table.

FIG. 8 is a flowchart illustrating recording processing with correction.

FIG. 9A is a diagram for explaining an effect of the present exemplary embodiment in a configuration in which a first direction obliquely intersects a second direction, and FIG. 9B is a diagram illustrating a comparative example with respect to FIG. 9A.

### DESCRIPTION OF EXEMPLARY EMBODIMENTS

Exemplary embodiments of the present disclosure will be described below with reference to the accompanying drawings. Note that, each of the drawings is merely illustrative for explaining the present exemplary embodiment. Because the drawings are exemplary, proportions and shapes are not precise, do not match each other, or some are omitted, in some cases.

1. Schematic Explanation of System:

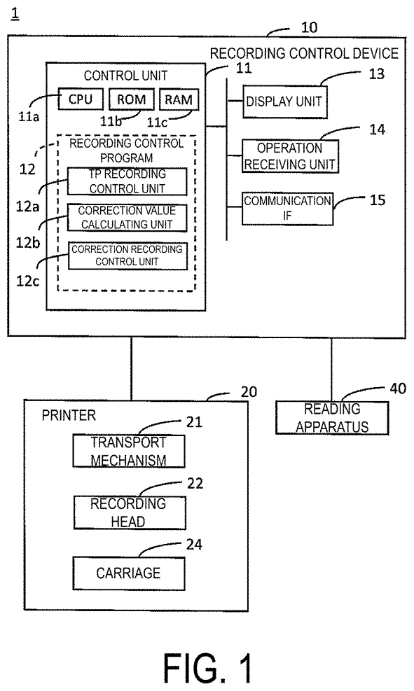

FIG. 1 simply illustrates a configuration of a system 1 according to the present exemplary embodiment. The system 1 includes a recording control device 10 and a printer 20. The system 1 may be referred to as a recording system, an image processing system, a printing system, or the like. At least a part of the system 1 realizes a correction value setting method and a test pattern recording method.

The recording control device 10 is realized by, for example, a personal computer, a server, a smart phone, a tablet terminal, or an information processing device having a similar degree of processing capability. The recording control device 10 includes a control unit 11, a display unit 13, an operation receiving unit 14, a communication interface 15, and the like. An interface is abbreviated as an IF. The control unit 11 is configured to include one or more ICs having a CPU 11a as a processor, a ROM 11b, a RAM 11c, and the like, other non-volatile memory, and the like.

In the control unit 11, the processor or the CPU 11a executes arithmetic processing according to a program stored in the ROM 11b, other memory, or the like, using the RAM 11c or the like as a work area. The control unit 11 executes processing according to a recording control program 12, and in cooperation with the recording control program 12, realizes a plurality of functions such as a TP recording control unit 12a, a correction value calculating unit 12b, and a correction recording control unit 12c. A test pattern is abbreviated as a “TP”. Note that, the processor is not limited to a single CPU, and a configuration may be adopted in which processing is performed by a plurality of CPUs or a hardware circuit such as an ASIC, or a configuration may be adopted in which a CPU and a hardware circuit cooperate to perform processing.

The display unit 13 is a means for displaying visual information, and is constituted, for example, by a liquid crystal display, an organic EL display, or the like. The display unit 13 may be configured to include a display and a driving circuit for driving the display. The operation receiving unit 14 is a means for receiving an operation by a user, and is realized by, for example, a physical button, a touch panel, a mouse, a keyboard, or the like. Of course, the touch panel may be realized as a function of the display unit 13. The display unit 13 and the operation receiving unit 14 can be collectively referred to as an operating panel of the recording control device 10.

The display unit 13 and the operation receiving unit 14 may be a part of the configuration of the recording control device 10, but may be a peripheral device externally attached to the recording control device 10. The communication IF 15 is a generic term for one or more IFs for the recording control device 10 to perform wired or wireless communication with an outside in accordance with predetermined communication protocols including known communication standards. The control unit 11 communicates with the printer 20 via the communication IF 15.

The printer 20 as a recording device controlled by the recording control device 10 is an inkjet printer that discharges dots of ink and performs recording. Dots are also referred to as droplets. Although a detailed explanation of the inkjet printer is omitted, the printer 20 generally includes a transport mechanism 21, a recording head 22, and a carriage 24. The transport mechanism 21 includes a roller for transporting a recording medium, a motor for driving the roller, and the like, and transports the recording medium in a predetermined transport direction.

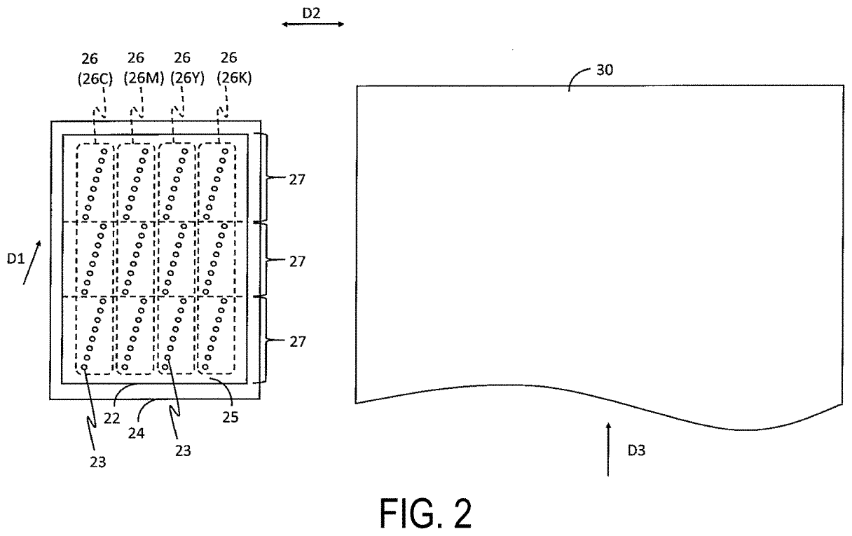

As illustrated in FIG. 2, the recording head 22 includes a plurality of nozzles 23 capable of discharging dots, and discharges dots from each of the nozzles 23 onto a recording medium 30 transported by the transport mechanism 21. The printer 20 does or does not discharge dots from the nozzles 23 by controlling application of a drive signal to a driving element (not illustrated) included in the nozzle 23 in accordance with dot data described below. For example, the printer 20 discharges inks of respective colors of cyan (C), magenta (M), yellow (Y), and black (K), an ink or a liquid of a color other than these colors, to perform recording. In the present exemplary embodiment, the printer 20 is described as of a type for discharging the CMYK inks.

FIG. 2 simply illustrates a relationship between the recording head 22 and the recording medium 30. The recording head 22 may be referred to as a printing head, a print head, a liquid discharging head, and the like. The recording medium 30 is typically paper, but may be a material other than paper as long as the material is a material on which recording by discharging of liquid can be performed. The recording head 22 is mounted on the carriage 24 that is reciprocally movable along a direction D2, and moves with the carriage 24. The direction D2 is also referred to as a main scanning direction D2. The transport mechanism 21 transports the recording medium 30 in a direction D3 that intersects the main scanning direction D2. The direction D3 is the transport direction. The intersection between the main scanning direction D2 and the transport direction D3 may be essentially interpreted to be orthogonal, but is not strictly orthogonal due to, for example, various errors in the printer 20 as a product in some cases.

A reference numeral 25 denotes a nozzle surface 25 in which the nozzle 23 in the recording head 22 opens. FIG. 2 illustrates an example of an arrangement of the nozzles 23 in the nozzle surface 25. Each small circle in the nozzle surface 25 is the nozzle 23. The recording head 22, in a configuration in which inks of the respective CMYK colors are supplied from an ink holding means (not illustrated), which is referred to as an ink cartridge, an ink tank, or the like, mounted on the printer 20, and are discharged from the nozzles 23, includes a nozzle row 26 for each ink color. The nozzle row 26 constituted by the nozzles 23 for discharging the C ink is also described as a nozzle row 26C. Similarly, the nozzle row 26 constituted by the nozzles 23 for discharging the M ink may be described as a nozzle row 26M, the nozzle row 26 constituted by the nozzles 23 for discharging the Y ink may be described as a nozzle row 26Y, and the nozzle row 26 constituted by the nozzles 23 for discharging the K ink may be described as a nozzle row 26K. The nozzle rows 26C, 26M, 26Y, and 26K are arranged along the main scanning direction D2.

The nozzle row 26 corresponding to one ink color is constituted by a plurality of the nozzles 23 in which a nozzle pitch, which is an interval between the nozzles 23 in the transport direction D3 is constant. A direction in which the plurality of nozzles 23 constituting the nozzle row 26 are arranged is referred to as a nozzle row direction D1. The nozzle row direction D1 corresponds to a “first direction”, and the main scanning direction D2 corresponds to a “second direction”. The nozzle row 26K corresponds to a “first nozzle row” in which a plurality of the nozzles 23 that discharge K ink are arranged in the first direction. Each of the nozzle rows 26C, 26M, and 26Y corresponds to a “second nozzle row” in which a plurality of the nozzles 23 that discharge a chromatic ink are arranged in the first direction. In the example of FIG. 2, the nozzle row direction D1 is not parallel to the transport direction D3. Accordingly, the nozzle row direction D1 obliquely intersects the main scanning direction D2. Of course, a configuration may be adopted in which the nozzle row direction D1 is parallel to the transport direction D3. In the configuration in which the nozzle row direction D1 is parallel to the transport direction D3, the nozzle row direction D1 is orthogonal to the main scanning direction D2.

In the example of FIG. 2, the recording head 22 is configured by joining a plurality of similar nozzle tips 27 along the transport direction D3. Each of the nozzle chips 27 has a nozzle group for the respective ink colors of CMYK by a plurality of the nozzles 23 arranged in the nozzle row direction D1, and such a group of the nozzles for each of CMYK are arranged along the transport direction D3 to form the nozzle rows 26C, 26M, 26Y, or 26K for each of CMYK. Respective positions of the nozzle rows 26C, 26M, 26Y, and 26K in the transport direction D3 may be understood to be mutually matched.

According to the example of FIG. 2, the printer 20 is a so-called serial type printer, and alternately repeats transport of the recording medium 30 by a predetermined transport amount in the transport direction D3 and ink discharge by the recording head 22 associated with movement of the carriage 24 along the main scanning direction D2, to perform recording on the recording medium 30. Ink discharge by the recording head 22 associated with forward movement or return movement of the carriage 24 along the main scanning direction D2 is also referred to as a scanning or a pass.

The recording control device 10 further is communicatively coupled with the reading apparatus 40. The reading apparatus 40 is a generic term of a device for reading a color of the recording medium 30. The reading apparatus 40 may be, for example, a colorimeter or a scanner. The reading apparatus 40 may be a part of the recording control device 10.

The recording control device 10 may also be coupled to the printer 20 through a network (not illustrated). In addition to a printing function, the printer 20 may be a composite machine that combines a plurality of functions such as a function as a scanner, and a facsimile communication function. The recording control device 10 may be realized not only by one independent information processing device, but may also be realized by a plurality of information processing devices communicatively coupled to each other via a network.

Alternatively, the recording control device 10 and the printer 20 may be a recording device in which they are integrated. In other words, the recording control device 10 is a part of a configuration included in the printer 20 as the recording device, and processing performed by the recording control device 10 described below may be interpreted as processing performed by the printer 20. The recording device according to the present exemplary embodiment is capable of recording a TP, thus corresponds to a TP recording device.

2. Correction Value Setting Method:

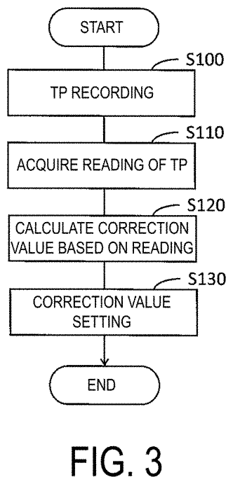

FIG. 3 illustrates by a flowchart, a correction value setting method that the control unit 11 implements according to the recording control program 12. The correction value setting method includes a TP recording method. A correction value is information for correction of density irregularity for each raster line constituting an image. The “raster line” is a line elongated in the main scanning direction D2, which is represented by pixels arranged in the main scanning direction D2. The density irregularity for each raster line is caused by a variation in discharge characteristics of ink per nozzle 23 used in recording of the raster line.

In step S100, the TP recording control unit 12a causes the printer 20 to record a TP in which a plurality of patches having densities different from each other are arranged in the main scanning direction D2. TP data, which is image data representing a TP, is prepared in advance in a predetermined memory or the like. The TP data is bitmap data, in which each pixel has a tone value indicating an ink amount for each of CMYK. The tone value indicates, for example, 256 tones from 0 to 255. The TP recording control unit 12a performs halftone processing on the TP data. A specific technique of the halftone processing is not particularly limited, and a dither method, an error diffusion method, and the like may be employed. The halftone processing generates dot data defining dot discharge (dot-on) or non-discharge (dot-off) for the respective inks of CMYK for each pixel.

The TP recording control unit 12a rearranges the generated dot data in order to be transferred to the printer 20 according to a predetermined recording mode. This processing of the rearrangement is also referred to as rasterization processing. The recording mode is a combination of various recording conditions, and a difference between recording modes is a difference in movement of the transport mechanism 21, the recording head 22, and the carriage 24 employed in the printer 20, for example. Different nozzles 23 may be used for recording a raster line depending on recording modes. Examples of the recording mode include, for example, a mode in which one raster line is recorded in a single pass, and a mode in which one raster line is recorded in two or more passes. In addition, for example, there is a mode in which a recording resolution in the transport direction D3 is increased by setting a transport amount of the recording medium 30 by the transport mechanism 21 between a pass and a pass to a distance that is shorter than a nozzle pitch.

The rasterization processing determines, at which timing, in which pass, and by which nozzle 23, dots of ink defined by dot data are discharged, depending on a pixel position and an ink color. The TP recording control unit 12a transmits an instruction of the recording mode and the dot data after the rasterization processing to the printer 20. The printer 20, based on the instruction of the recording mode and the dot data transmitted from the recording control device 10, drives the transport mechanism 21, the recording head 22, and the carriage 24, to record the TP on the recording medium 30.

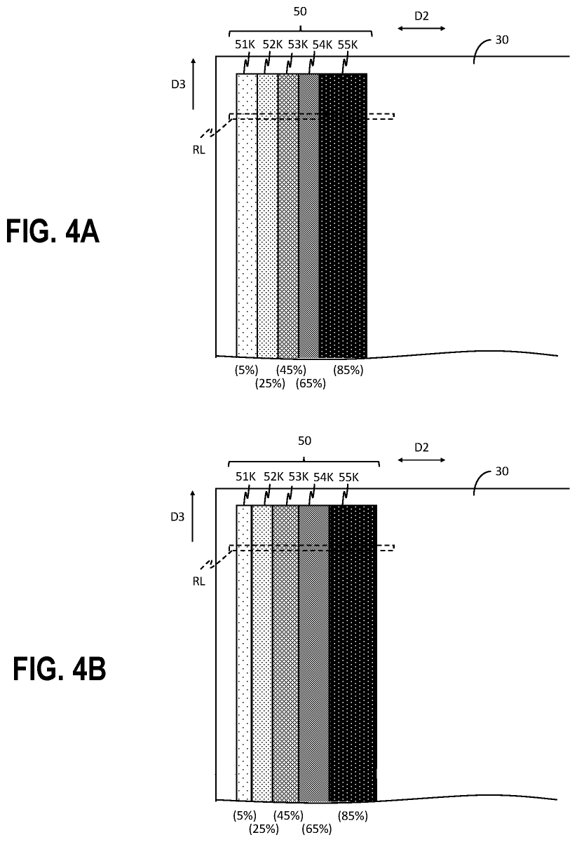

FIG. 4A illustrates a TP 50 recorded on the recording medium 30 based on the TP data in step S100. In the TP 50, band-like patches 51K, 52K, 53K, 54K, and 55K elongated in the transport direction D3 are arranged in the main scanning direction D2. An individual patch may be referred to as a band region or referred to as a density region. The patches 51K to 55K included in the TP 50 have densities different from each other, and are each recorded with an identical ink of one color. The TP 50 illustrated in FIG. 4A is formed by recording all of the patches 51K to 55K with the K ink. In other words, the TP 50 is a TP recorded by the nozzle row 26K. In FIG. 4A, for ease of understanding, the density of each of the patches 51K to 55K is illustrated in parentheses. In the TP 50, the patch 51K is a lowest density patch and the patch 55K is a highest density patch. A highest density patch among a plurality of patches constituting a TP is referred to as a “first patch”, and patches other than the first patch among the plurality of patches constituting the TP are referred to as “second patches”. In the TP 50, the patch 55K is the first patch, and each of the patches 51K to 54K is the second patch.

A density of a patch means a ratio of dot-on pixels in a region of the patch, or a coverage factor by ink for the region. In the TP data representing the TP 50, each of the patches 51K to 55K is a collection of pixels having a tone value corresponding to a density thereof. A density range from 0% to 100% may be normalized to a tone range from 0 to 255. In the TP data representing the TP 50, the patch 51K is formed by, for example, collecting pixels having a tone value of K of “13” corresponding to a density of 5%, namely, pixels of (C, M, Y, K)=(0, 0, 0, 13).

In FIG. 4A, a region indicated by a dashed line illustrates one of raster lines RL. The raster line RL passing through the TP 50 passes through all of the patches 51K to 55K. The raster line RL is recorded using one or more nozzles 23 included in the nozzle row 26K. Step S100 for recording such a TP on the recording medium 30 corresponds to a recording step.

Effects of the TP of the present exemplary embodiment will now be described.

In step S100, the TP recording control unit 12a causes the printer 20 to record a TP having a length in the second direction of the first patch that is equal to or greater than a length in the second direction of each of the second patches, and is greater than a length in the second direction of at least one of the second patches. In the example of FIG. 4A, the lengths in the main scanning direction D2 of the respective patches 51K to 54K are identical, and the length in the main scanning direction D2 of the patch 55K is greater than the length in the main scanning direction D2 of each of the patches 51K to 54K. That is, among the plurality of patches constituting the TP 50, only the length in the main scanning direction D2 of the patch 55K is greater than the of each of the other patches 51K to 54K.

Some second patches may have an identical length in the second direction to that of the first patch. For example, a configuration may be adopted in which, in the TP 50, the patch 54K having the second highest density after the patch 55K may have an identical length in the main scanning direction D2 to that of the patch 55K, and the length of each of the patch 54K and the patch 55K may have the length in the main scanning direction D2 that is greater than the length of each of the other patches 51K to 53K.

FIG. 4B illustrates the TP 50 recorded on the recording medium 30 based on the TP data by step S100, that is, an example different from FIG. 4A. A meaning of each reference numeral illustrated in FIG. 4B is identical to that in FIG. 4A. In accordance with the example of FIG. 4B, the length in the main scanning direction D2 of each of the patches 51K to 55K constituting the TP 50 is greater for a patch with a higher density. In other words, for the patches 51K to 54K, that are the second patches, the lengths in the main scanning directions D2 may be different from each other, and the length in the main scanning direction D2 may be greater for a patch with a higher density.

Note that, in step S100, the TP recording control unit 12a causes the printer 20 to record the TP for each ink color. In other words, TP data is image data representing a TP by a single color of each ink color.

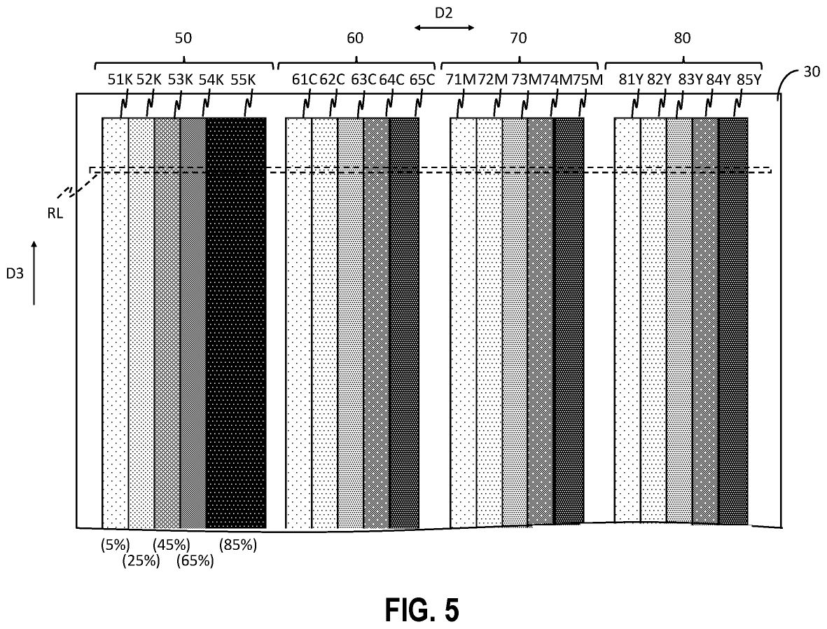

FIG. 5 illustrates the TP 50, 60, 70, and 80 recorded on the recording medium 30 based on the TP data by step S100. The TP 50 is as previously described. In the example of FIG. 5, the TPs 50 to 80 are recorded side by side in the main scanning direction D2. The TP 60 is a TP where each of the patches 61C, 62C, 63C, 64C, and 65C is recorded with the C ink by the nozzle row 26C. The TP 70 is a TP where each of the patches 71M, 72M, 73M, 74M, and 75M is recorded with the M ink by the nozzle row 26M. The TP 80 is a TP where each of the patches 81Y, 82Y, 83Y, 84Y, and 85Y is recorded with the Y ink by the nozzle row 26Y. Each of the TPs 60 to 80, like the TP 50, is a band-like patch that is elongated in the transport direction D3, and is configured by arranging a plurality of patches having densities different from each other in the main scanning direction D2.

The TP 50 corresponds to a “first TP” and each of the TPs 60 to 80 corresponds to a “second TP”. In the TP 60, a patch 65C is a first patch with a highest density, and patches 61C to 64C other than the patch 65C are second patches. Similarly, in the TP 70, a patch 75M is a first patch with a highest density, and patches 71M to 74M other than the patch 75M are second patches. In the TP 80, a patch 85Y is a first patch with a highest density, and patches 81Y to 84Y other than the patch 85Y are second patches.

As can be seen in FIG. 5, in a relationship among the TPs for the respective ink colors recorded in step S100, the length in the main scanning direction D2 of the patch 55K, which is the first patch of the TP 50, is greater than the respective lengths in the main scanning direction D2 of the patches 65C, 75M, and 85Y, which are the first patches of the TP 60, 70, and 80 of chromatic colors respectively.

In the example of FIG. 5, there is no difference in length in the main scanning direction D2 between the first patch and the second patches in terms of the TP 60 to TP 80 of the chromatic colors.

However, even in the TP 60 to TP 80 of the chromatic colors, similar to the TP 50 of the K ink, the first patch may be different from the second patch in length in the main scanning direction D2, or the lengths of the respective second patches in the main scanning direction D2 may be different from each other.

An effect of recording the TP of such a feature will be described later.

The description will be continued with reference to FIG. 3.

In step S110, the correction value calculating unit 12b acquires a reading of the TP recorded in step S100. In this case, the reading apparatus 40 reads the TP recorded on the recording medium 30, and the correction value calculating unit 12b acquires the reading, which is a reading result, from the reading apparatus 40. The processing in which the reading apparatus 40 reads the TP, or the processing in which the correction value calculating unit 12b acquires the reading corresponds to a reading step. A color system employed for the reading acquired by the correction value calculating unit 12b is not particularly limited. The correction value calculating unit 12b acquires, for example, as the reading, a color value represented by L*, a*, and b* components of a CIE L*a*b* color space defined by the International Commission on Illumination (CIE) from the reading apparatus 40, which is a colorimeter. Alternatively, the correction value calculating unit 12b acquires, as a reading, image data represented by RGB (red, green, blue) components from the reading apparatus 40, which is a scanner.

In step S120, the correction value calculating unit 12b calculates a correction value for correcting an ink amount for each raster line RL based on the reading acquired in step S110. Step S120 corresponds to a calculating step.

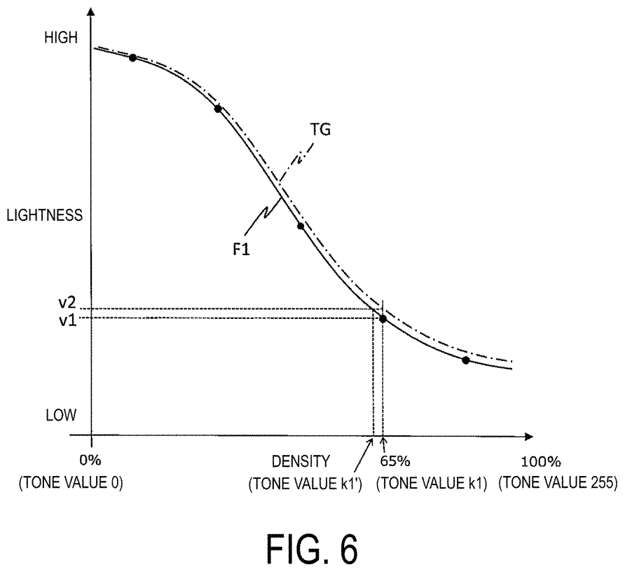

FIG. 6 is a diagram for explaining processing of the correction value calculation in step S120. In FIG. 6, a graph based on the readings acquired in step S110 is indicated by a solid line. In FIG. 6, a horizontal axis indicates density of each of the patches 51K to 55K of the TP 50, and a vertical axis indicates lightness as the readings. The lightness as the reading is lightness L* inputted from the reading apparatus 40. Alternatively, the lightness as the reading may be a value obtained by weighting and adding values calculated by the control unit 11 based on information inputted from the reading apparatus 40, for example, RGB components.

In the graph of FIG. 6, five black circles spaced in a lateral direction at regular intervals indicate the lightness of the patches 51K to 55K of the TP 50 respectively. More specifically, the lightness of each patch indicated by the black circle is the lightness of each patch in one raster line RL included in the TP 50. The lightness of one patch in one raster line RL is, for example, an average value of the lightness of the patch in the raster line RL. A solid line connecting the black circles is a function F1 that the correction value calculating unit 12b generates by an interpolation calculation based on the lightness indicated by the black circles. The interpolation calculation may be non-linear interpolation or linear interpolation.

In FIG. 6, a function TG indicated by a dot-dash line is a function serving as a reference for correction. The function TG is, for example, a curve generated by performing the interpolation calculation on the lightness of each of the patches 51K to 55K in a target raster line. The target raster line is also one of the raster lines RL included in the recorded TP 50. There are various methods of determining the target raster line. For example, it is assumed that a predetermined nozzle 23 of the nozzle row 26K is defined as a target nozzle, and the correction value calculating unit 12b sets the raster line RL recorded by this target nozzle as a target raster line. Alternatively, the correction value calculating unit 12b determines, for example, the raster line RL for which a reading for a specific patch among the patches 51K to 55K is closest to lightness of a predefined reference, of the raster lines RL included in the TP 50, as the target raster line. Alternatively, the function TG defining each ideal value as a reading of each of the patches 51K to 55K of the TP 50 may be stored in advance in a predetermined memory of the control unit 11.

In accordance with the example of FIG. 6, lightness indicated by the function F1 corresponding to a density of 65% is lightness v1, and lightness indicated by the function TG corresponding to the same density 65% is lightness v2. In this case, the correction value calculating unit 12b sets a density for obtaining the lightness v2 in the function F1 to a corrected density for the density of 65%. Assume that a tone value of K in a 256 tone range corresponding to the density of 65% is “k1”, and a tone value of K in the 256 tone range corresponding to a corrected density for the density of 65% is “k1′”. In this case, the correction value calculating unit 12b uses “k1′−k1” as a correction value for the tone value k1 of K. For example, when k1=166 and k1′=161, then “−5” is the correction value for the tone value k1 of K. If k1′>k1, the correction value for the tone value k1 is a positive value. Using the function F1 and the function TG described above, the correction value calculating unit 12b calculates correction values for all tone values from 0 to 255 of K including the tone value k1.

The correction value calculating unit 12b sequentially targets the raster lines RL included in the TP 50 based on the reading acquired in step S110, and calculates the correction values for the tone values from 0 to 255 of K for each raster line RL included in the TP 50. However, when any of the raster lines RL included in the TP 50 is used as the target raster line, as for the target raster line, the correction value is set to zero because the correction value is substantially absent.

In step S130, the correction value calculating unit 12b sets the correction value for each raster line RL calculated in step S120 as described above to the correction value to apply to the recording processing. In this case, the correction value calculating unit 12b associates the correction value for each raster line RL with the recording mode employed for recording the TP in step 5100, and stores the correction value in the predetermined memory of the recording control device 10. Step S130 corresponds to a setting step.

Of course, in steps 5120 and 5130, the correction value calculating unit 12b calculates and sets the correction value also for each ink color of CMY as described above. In other words, the correction value calculating unit 12b calculates and sets a correction for of the tone value of each of CMY, based on the respective readings of the TP 60, 70, and 80 recorded on the recording medium 30. As a result, the correction value for each raster line, for each of CMYK, and for each tone value is set.

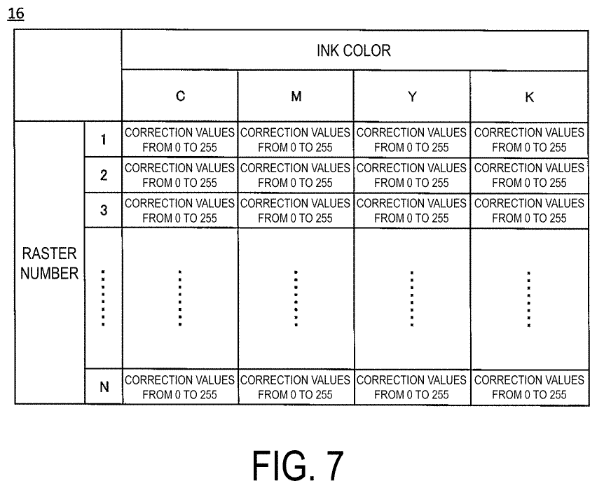

FIG. 7 illustrates, as a result of step S130, a correction value table 16 stored in correspondence with the recording mode employed for recording the TP in step S100. In the correction value table 16, the correction values calculated in step S120 are stored in correspondence with the ink colors of CMYK and raster numbers from 1 to N. In FIG. 7, “correction values from 0 to 255” is a representation summarizing presence of the correction values for the respective tone values from 0 to 255. The raster number is a number for each raster line RL of an image recorded according to the recording mode employed for recording the TP in step S100, and the control unit 11 uses the raster number to manage the correction value for each raster line RL. The raster number is given, for example, to each raster line RL constituting one page of images, from downstream to upstream in the transport direction D3.

3. Recording Processing with Correction:

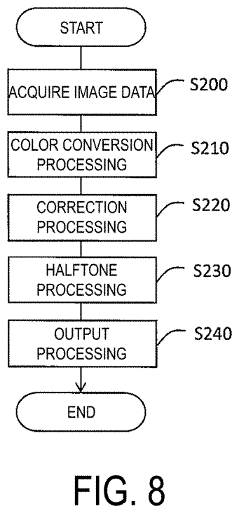

FIG. 8 illustrates, in flowchart, recording processing for causing the printer 20 to record an input image that is arbitrarily selected. The recording processing is also realized by the control unit 11 according to the recording control program 12. The recording processing involves correction processing using the correction value calculated as described above.

A user, for example, manipulates the operation receiving unit 14 while viewing a UI screen displayed on the display unit 13, to arbitrarily select image data representing the input image. A UI is an abbreviation for an interface. The user arbitrarily selects a recording mode to employ in the recording processing, or changes the selection of the predetermined recording mode. In step S200, the correction recording control unit 12c acquires image data that is arbitrarily selected by the user from a predetermined input source.

The image data acquired in step S200 is bitmap data having a plurality of pixels similar to TP data, and has tone values of RGB for each pixel, for example. When the acquired image data does not correspond to such an RGB color system, the correction recording control unit 12c converts the acquired image data to data in the color system. Furthermore, the correction recording control unit 12c performs resolution conversion processing on the image data to match a recording resolution corresponding to the selected recording mode.

In step S210, the correction recording control unit 12c performs color conversion processing on the image data after step S200 as a target. In other words, the color system of the image data is converted to the color system of the ink used by the printer 20 for recording. As described above, when the image data represents a color of each pixel using tones by RGB, the tone values of RGB are converted to tone values of the respective CMYK for each pixel. The color conversion processing can be performed by referring to any color conversion lookup table defining a conversion relationship from RGB to CMYK.

In step S220, the correction recording control unit 12c uses the correction value stored in the correction value table 16 to correct the image data after the color conversion obtained in step S210, that is, image data in which each pixel has a tone value indicating an ink amount for each of CMYK. The correction value table 16 referred to by the correction recording control unit 12c in step S220 is, of course, the correction value table 16 stored in correspondence with the selected recording mode. Here, it is assumed that the correction value table 16 corresponding to the recording mode selected by the user is already stored. The correction recording control unit 12c corrects the tone value for each of CMYK of each pixel constituting the image data after the color conversion, with the correction value to which the raster number N of the raster line to which the pixel belongs, the ink color, and the tone value correspond. This correction increases or decreases the ink amount indicated by the tone value.

In step S230, the correction recording control unit 12c performs halftone processing on the image data after the correction processing by step S220, and generates dot data.

In step S240, the correction recording control unit 12c performs output processing for causing the printer 20 to perform recording based on the dot data generated by step S230. In other words, the correction recording control unit 12c applies the rasterization processing according to the selected recording mode to the dot data, and transmits the dot data after the rasterization processing to the printer 20 along with an instruction of the selected recording mode. The printer 20, based on the instruction of the recording mode and the dot data transmitted from the recording control device 10, drives the transport mechanism 21, the recording head 22, and the carriage 24, to record the TP on the recording medium 30. The input image recorded in this manner has good image quality in which density irregularity for each raster line is corrected.

4. Summary:

As described above, according to the present exemplary embodiment, the correction value setting method includes the recording step for driving the recording head 22 having the plurality of nozzles 23 arranged in the first direction, and discharges ink from the nozzle 23, to record the TP in which the plurality of patches having densities different from each other are arranged in the second direction intersecting the first direction on the recording medium 30, the reading step for reading the TP recorded on the recording medium 30, the calculating step for calculating the correction value for each raster line elongated in the second direction recorded by the one or more nozzles 23 in the TP, that is the correction value for correcting the ink amount, based on the reading of the TP in the reading step, and the setting step for setting the correction value for each raster line as the correction value to be used for the recording processing. Then, when the maximum density patch among the plurality of patches constituting the TP is the first patch, and the patches other than the first patch among the plurality of patches constituting the TP are the second patches, in the recording step, the length in the second direction of the first patch is made equal to or greater than the length in the second direction of each of the second patches, and greater than the length in the second direction of at least one second patch, and the TP is recorded.

According to the configuration described above, in the plurality of patches constituting the TP, the length in the second direction of the first patch is made relatively great, and recording on the recording medium 30 is performed. This makes accurate readings more likely to be obtained for the first patch, which is the highest density patch in the TP. Since an accurate value as the reading of the TP is obtained, an appropriate value is also calculated for the correction value, and as a result, correction of density irregularity for each raster line using the correction value is appropriately performed.

In addition, the present exemplary embodiment discloses the TP recording method for driving the recording head 22 having the plurality of nozzles 23 arranged in the first direction to discharge ink from the nozzle 23 to record the TP on the recording medium 30, wherein when the maximum density patch in the TP in which the plurality of patches having densities different from each other are arranged in the second direction intersecting the first direction is the first patch, and the patches other than the first patch among the plurality of patches that constitute the TP are the second patches, the length in the second direction of the first patch is made equal to or greater than the length in the second direction of each of the second patches, and greater than the length in the second direction of at least one of the second patches, and the TP is recorded.

In addition, the present exemplary embodiment discloses the TP recording device for driving the recording head 22 having the plurality of nozzles 23 arranged in the first direction to discharge ink from the nozzle 23, thereby recording the TP on the recording medium 30, wherein when the maximum density patch in the TP in which the plurality of patches having densities different from each other are arranged in the second direction intersecting the first direction is the first patch, and the patches other than the first patch among the plurality of patches that constitute the TP are the second patches, the length in the second direction of the first patch is made equal to or greater than the length in the second direction of each of the second patches, and greater than the length in the second direction of at least one of the second patches, and the TP is recorded.

The effect of the characteristics of the TP according to the present exemplary embodiment will be described in more detail.

When the TP recorded on the recording medium 30 is read with the reading apparatus 40, in particular for the first patch having a high density, due to effects by a color of the recording medium 30 itself (for example, white) around the first patch, and a color of the second patch, a lighter color than an original color of the first patch is obtained as a reading in some cases. That is, due to effects of reflected light from outside the first patch, the color of the first patch is not accurately read in some cases. In the present exemplary embodiment, for such a problem, the length in the second direction of the first patch among the plurality of patches of the TP is made relatively great and the TP is recorded. That is, the first patch is increased. Thus, a degree of effect of the color around the first patch on the reading of the first patch is relatively reduced, and the color of the first patch can be accurately read.

Note that, there is an aspect in which when the TP recorded on the recording medium 30 is read with the reading apparatus 40, a reading affected by a color of the surrounding recording medium 30 or the like is obtained also for the second patch. However, since the second patch is lower in density than the first patch, fluctuation in readings generated by the effect of the surrounding color is small. Thus, a need for recording the second patch in a large size as in the case of the first patch is small. In addition, when all of the patches are recorded in large sizes as in the case of the first patch, consumption of the ink and the recording medium 30 is increased. According to the present exemplary embodiment, for at least one of the second patches, the length in the second direction is made less than that of the first patch, so it is possible to avoid unnecessarily consuming ink or the like.

According to the present exemplary embodiment, the recording head 22 includes the first nozzle row in which the plurality of nozzles 23 discharging the K ink are arranged in the first direction, and the second nozzle row in which the plurality of nozzles 23 discharging the chromatic ink are arranged in the first direction. Then, in the recording step, the first nozzle row is used to record the first TP in which the plurality of patches having densities of K different from each other are arranged in the second direction, and the second nozzle row is used to record the second TP in which the plurality of patches having densities of the chromatic color are arranged in the second direction. In this case, the length in the second direction of the first patch in the first TP may be made greater than the length in the second direction of the first patch in the second TP to record the TPs.

A darkest color among the plurality of ink colors including the chromatic colors such as CMY and K, is K, and the patch for which the reading is most likely to fluctuate by being affected by the surrounding color in the patches of K is the first patch of K. Thus, the length in the second direction of the first patch in the first TP is made greater than the length in the second direction of the first patch in the second TP. Thus, as described above, the reading of the patch for which the reading is most likely to fluctuate can be stabilized and accurately read, and consumption of the ink and the recording medium 30 with respect to the TP recording can be entirely suppressed.

Further, according to the present exemplary embodiment, in the recording step, for the respective lengths in the second direction of the plurality of second patches, a patch with a higher density may be made greater, to record the TP.

According to the configuration described above, by increasing the length in the second direction corresponding to a height of the density for each second patch in the TP, the reading of each second patch in addition to the first patch can be acquired more accurately.

Further, according to the present exemplary embodiment, the first direction may obliquely intersect the second direction. Intersecting obliquely means intersecting at an angle that is not a right angle.

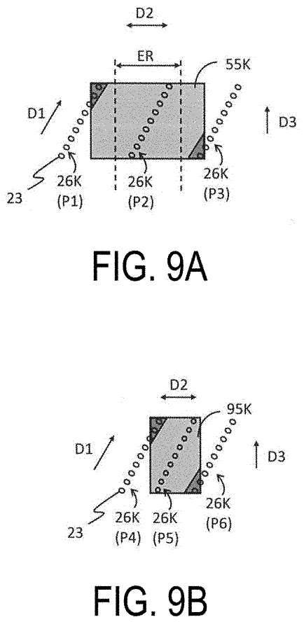

FIG. 9A is a diagram for explaining an effect of the present exemplary embodiment in a configuration in which the nozzle row direction D1, which is the first direction, obliquely intersects the main scanning direction D2, which is the second direction. FIG. 9B also illustrates a comparative example to FIG. 9A.

FIG. 9A illustrates a part of the patch 55K in the TP 50 recorded on the recording medium 30 in step S100. In FIG. 9A, in favor of visibility, the color of the patch 55K is expressed as thinner than that of the patch 55K in FIGS. 4A, 4B, and 5. FIG. 9A also illustrates the nozzle row 26K used for recording the patch 55K. Of course, the nozzle row 26 illustrated in FIG. 9A is a part of the actual nozzle row 26K. The nozzle row 26 illustrated in FIG. 9A may be understood as a group of nozzles for discharging the K ink contained in any one of the nozzle tips 27 illustrated in FIG. 2.

In FIG. 9A, a reference numeral such as “P1”, which is described in conjunction with the reference numeral “26K”, indicates a position of the nozzle row 26K. In other words, in order to identify the position of the nozzle row 26K that changes as the carriage 24 moves along the main scanning direction D2, reference numerals P1, P2, and P3 are used. In FIG. 9A, for example, the carriage 24 moves from left to right in the figure, with this movement the position of the nozzle row 26K changes in an order of the positions P1, P2, and P3.

In a configuration in which the nozzle row direction D1 obliquely intersects the main scanning direction D2, as can be seen from FIG. 9A, when the nozzle row 26K is located at the position P1, only a limited number of the nozzles 23 at one end in the nozzle row direction D1 of the nozzle row 26K are used for recording the patch 55K. Similarly, when the nozzle row 26K is located at the position P3, only a limited number of the nozzles 23 at another end in the nozzle row direction D1 of the nozzle row 26K are used for recording the patch 55K. Compared to this, when the nozzle row 26K is located at the position P2, the entire nozzle row 26K is located at a position where the nozzle row 26K can record the patch 55K, thus, the entire nozzle row 26K is used for recording the patch 55K. Of course, even when the entire nozzle row 26K is used, each nozzle 23 does or does not discharge dots, when noting the movement of each nozzle 23. However, compared to the positions P1 and P3, many nozzles 23 in the nozzle row 26K simultaneously discharge dots at the position P2.

When dots discharged by the nozzle 23 when the number of nozzles simultaneously discharging dots in the nozzle row 26K for recording of the patch 55K is small as at the positions P1 and P3, are compared to dots discharged by the nozzle 23 when the number of nozzles simultaneously discharging dots in the nozzle row 26K for recording the patch 55K is large as at the position P2, a difference in liquid volume per drop occurs. Such a difference is caused by structure of the nozzle row 26 including the plurality of nozzles 23 each capable of discharging dots by receiving the same supply of ink in a common ink supply path, and is caused by a difference in pressure and vibration experienced by the nozzle 23, and the like. Such differences are represented as a shading difference in a patch.

In FIG. 9A, an upper left corner portion of the patch 55K recorded by the nozzle row 26K at the position P1, and a lower right corner portion of the patch 55K recorded by the nozzle row 26K at the position P3 are expressed as darker than portions of the patch 55K other than these corner portions. For ease of understanding, in FIG. 9A, the shading difference between these corner portions and the portions other than the corner portions is more clearly expressed than actual.

According to the configuration in which the nozzle row direction D1 obliquely intersects the main scanning direction D2, even when the input image illustrated in FIG. 8 is recorded on the recording medium 30, a shading difference such as the shading difference between the corner portions and the portions other than the corner portions in the patch occurs in a recording result. However, in the recording of the input image, the corner portions as described above occur only at both end portions in the main scanning direction D2 of the recording medium for one page respectively, and there is a slight presence in an entire recording result for one page. When the correction value calculated in consideration of the color of the corner portion in the patch is applied to the input image, quality of a recording result is likely to be entirely reduced instead. Thus, when the reading of the patch for calculation of the correction value used in recording the input image is acquired, it is desirable to eliminate the color of the corner portion as described above.

How to read FIG. 9B is similar to FIG. 9A. FIG. 9B illustrates a part of a maximum density patch 95K in a TP recorded by the K ink on the recording medium 30. A length in the main scanning direction D2 of the patch 95K is similar to that of a second patch, and is smaller than that of the patch 55K. That is, the patch 95K is the highest density patch of the TP recorded by the K ink thus far. As can be seen from FIG. 9B, when the nozzle row 26K is located at a position P4, only a limited number of the nozzles 23 at one end in the nozzle row direction D1 of the nozzle row 26K are used for recording the patch 95K. Similarly, when the nozzle row 26K is located at a position P6, only a limited number of the nozzles 23 at another end in the nozzle row direction D1 of the nozzle row 26K are used for recording the patch 95K. Compared to this, when the nozzle row 26K is located at a position P5, the entire nozzle row 26K is located at a position where the nozzle row 26K can record the patch 95K, thus, the entire nozzle row 26K is used for recording the patch 95K. Thus, as in the case in the patch 55K, a shading difference between corner portions and portions other than corner portions occurs as described above also in the patch 95K.

Since a length in the main scanning direction D2 of the patch 95K is small, an area ratio of the corner portions in the patch is high, and when a reading of the patch 95K that is a reading of each raster line is acquired, a reading including a color of the corner portions is easily obtained. Compared to this, the length in the main scanning direction D2 of the patch 55K recorded in the present exemplary embodiment is greater than that of the patch 95K. Thus, an area ratio of the corner portions in the patch is lower than in the past, and when a reading of the patch 55K that is a reading of each raster line is acquired, a reading from portions excluding the corner portions is easily acquired. That is, according to the present exemplary embodiment, even in a configuration where the first direction obliquely intersects the second direction, an appropriate reading is easily obtained for calculating a correction value for the first patch, which is the maximum density patch in the TP.

As described above, in steps S110 and S120, when the correction value calculating unit 12b acquires a reading (for example, lightness) for each raster line and for each patch included in the recorded TP, the correction value calculating unit 12b averages and acquires readings within a raster line and within a patch. At this time, the correction value calculating unit 12b, in a limited specific range of a patch center portion excluding both patch end portions in the main scanning direction D2, may acquire a value obtained by averaging readings. In FIG. 9A, a specific range ER within the patch 55K is illustrated. The specific range ER is a range of the patch 55K excluding both patch end portions in the main scanning direction D2 including the corner portions. By acquiring the reading of the patch 55K for each raster line in the limited specific range ER, the correction value can be calculated based on the reading of the appropriate patch 55K excluding the effect of the color around the patch 55K and the color of the corner portions. A position and a size of the specific range ER relative to the patch 55K are predetermined. Note that, since the length in the main scanning direction D2 of the patch 95K in the past illustrated in FIG. 9B is small, it may be difficult to sufficiently ensure such a specific range ER.

5. Modification Example:

Various modification examples included in the present exemplary embodiment will be described.

The user may select a recording medium used by the printer 20 through the UI screen and instruct the recording medium to the control unit 11. Here, a recording mode including a condition for using a first recording medium as the recording medium 30 is referred to as a first recording mode. In addition, a recording mode including a condition for using a second recording medium as the recording medium 30 in which ink is more likely to bleed than the first recording medium is referred to as a second recording mode. The second recording medium is, for example, a standard paper, or a type of medium in which ink bleeds as easily as or more easily than a standard paper. It is sufficient that a medium other than the second recording medium among media available by the printer 20 is used as the first recording medium.

In the recording step in step S100, the recording control device 10, when the first recording mode in the first recording mode and the second recording mode is designated, causes the printer 20 to record a TP on the first recording medium, in which the length in the second direction of the first patch is made equal to or greater than the length in the second direction of each of the second patches, and greater than the length in the second direction of at least one of the second patches. On the other hand, when the second recording mode is designated, in the recording step, the recording control device 10 causes the printer 20 to record a TP on the second recording medium, in which the length in the second direction of the first patch is made equal to the length in the second direction of the second patches. Making the length in the second direction of the first patch equal to the length in the second direction of the second patch is, for example, with reference to the TP 50 of FIG. 4A, reducing the length in the main scanning direction D2 of the patch 55K to the same extent as the length in the main scanning direction D2 of each of the patches 51K to 54K.

In this way, as long as the first recording medium is used as the recording medium 30, the TP according to the present exemplary embodiment may be recorded. This is because, when the second recording medium in which ink easily bleeds is used, first, there is less density irregularity per raster line in a recording result, and there is a low need to improve the first patch as described in the present exemplary embodiment with respect to recording of the TP for calculating the correction value. When the second recording medium is used as the recording medium 30, consumption of ink or the like can be suppressed by making the first patch also have a similar size to that of the second patch.

In the present exemplary embodiment, the correction value calculated in step S120 by the correction value calculating unit 12b is not limited to a correction value for directly correcting a tone value for each ink color representing an input image. It is sufficient that a correction value is a correction value that increases or decreases an ink amount discharged from the recording head 22 by the printer 20. For example, a correction value may be information for correcting RGB tone values representing an input image, or may be information for correcting dot-on and dot-off defined by dot data representing an input image.

The printer 20 may be a so-called line printer rather than the serial type printer. When the printer 20 is a line printer, the previous description based on the serial type printer is changed as follows.

The carriage 24 is not required. The direction D3 illustrated in FIG. 2 and the like is referred to as a main scanning direction D3, rather than the transport direction. The direction D2 illustrated in FIG. 2 and the like is referred to as a transport direction D2, rather than the main scanning direction. The transport mechanism 21 transports the recording medium 30 in the transport direction D2. The recording head 22 is configured to be elongated with a length capable of covering a width of the recording medium 30 in the main scanning direction D3, by connecting the plurality of nozzle chips 27 along the main scanning direction D3, and is fixed to a predetermined position in a transport path of the recording medium 30. The transport direction D2 corresponds to a “second direction”, and in the recording step, a TP is recorded on the recording medium 30, in which a plurality of patches that are elongated in the main scanning direction D3 and have densities different from each other are arranged in the transport direction D2. The raster line RL is an elongated line in the transport direction D2.

According to the examples of FIG. 4A, FIG. 4B, and FIG. 5, the plurality of patches having densities different from each other and constituting a common TP are arranged in a density order in the second direction, and the first patch that is the patch having the maximum density in the TP and the second patch having the minimum density are located at both ends of TP respectively. In such a configuration, for example, in the TP 50, each of the patch 52K, 53K, and 54K in the second direction may be less in length than the patch 55K, on the other hand, the length in the second direction of the minimum density patch 51K may be greater than the length in the second direction of the patch 55K. That is, as an exception of the limitation “the length in the second direction of the first patch is made equal to or greater than the length in the second direction of each of the second patches”, a TP may be recorded in which some patches of the plurality of second patches are greater in length in the second direction than the first patch. In summary, in the recording step, the length in the second direction of the first patch is made greater than the length in the second direction of at least one of the second patches, and the TP is recorded.

What is claimed is:

1. A correction value setting method, comprising:
a recording step for driving a recording head having a plurality of nozzles arranged in a first direction to discharge ink from the nozzles, thereby recording, on a recording medium, a test pattern in which a plurality of patches having densities different from each other are arranged in a second direction that intersects the first direction;
a reading step for reading the test pattern recorded on the recording medium;
a calculating step for, based on a value read from the test pattern in the reading step, calculating a correction value for each of raster lines elongated in the second direction recorded by one or more of the nozzles in the test pattern, the correction value being used for correcting an ink amount; and
a setting step for setting a correction value for each of the raster lines as a correction value to be used for recording processing, wherein
when a patch with a maximum density of the plurality of patches constituting the test pattern is a first patch, and patches other than the first patch among the plurality of patches constituting the test pattern are second patches, recording is performed, in the recording step, so that a length in the second direction of the first patch is greater than a length in the second direction of at least one of the second patches.

2. The correction value setting method according to claim 1, wherein
the recording head includes a first nozzle row in which a plurality of nozzles for discharging black ink are arranged in the first direction, and a second nozzle row in which a plurality of nozzles for discharging a chromatic ink are arranged in the first direction, and
in the recording step, when the first nozzle row is used to record a first test pattern in which a plurality of patches having black densities different from each other are arranged in the second direction, and the second nozzle row is used to record a second test pattern in which a plurality of patches having chromatic color densities different from each other are arranged in the second direction, recording is performed so that a length in the second direction of the first patch in the first test pattern is greater than a length in the second direction of the first patch in the second test pattern.

3. The correction value setting method according to claim 1, wherein,
in the recording step, each of a plurality of the second patches is recorded so that a patch having a higher density has a greater length in the second direction.

4. The correction value setting method according to claim 1, wherein
the first direction obliquely intersects the second direction.

5. The correction value setting method according to claim 1, wherein
in the recording step, when, among a first recording mode in which a first recording medium is used as the recording medium and a second recording mode in which a second recording medium, in which ink more easily bleeds than in the first recording medium, is used as the recording medium, the first recording mode is designated, the test pattern is recorded on the first recording medium so that a length in the second direction of the first patch is greater than a length in the second direction of at least one of the second patches, and when the second recording mode is designated, the test pattern is recorded on the second recording medium so that the length in the second direction of the first patch is identical to the length in the second direction of the second patch.

6. A test pattern recording method for driving a recording head having a plurality of nozzles arranged in a first direction to discharge ink from the nozzles, thereby recording a test pattern on a recording medium, wherein
when a patch with a maximum density in the test pattern in which a plurality of patches having densities different from each other are arranged in a second direction that intersects the first direction is a first patch, and patches other than the first patch among the plurality of patches constituting the test pattern are second patches, the test pattern is recorded so that a length in the second direction of the first patch is greater than a length in the second direction of at least one of the second patches.

7. A test pattern recording device for driving a recording head having a plurality of nozzles arranged in a first direction to discharge ink from the nozzles, thereby recording a test pattern on a recording medium, wherein
when a patch with a maximum density in the test pattern in which a plurality of patches having densities different from each other are arranged in a second direction that intersects the first direction is a first patch, and patches other than the first patch among the plurality of patches constituting the test pattern are second patches, the test pattern is recorded so that a length in the second direction of the first patch is greater than a length in the second direction of at least one of the second patches.
